(19) United States
(12) Patent Application Publication
(10) Pub. No.: US 2011/0100860 A1
(43) Pub. Date: May 5, 2011

(54) Modular Storage Container

(76) Inventors: James B. Brown, Crystal Lake, IL (US); Will Lewallen, Pine Village, IN (US); Todd Blaising, Mansfield, OH (US); Leonard W. Baker, Lafayette, IN (US)

(21) Appl. No.: 12/910,956

(22) Filed: Oct. 25, 2010

Related U.S. Application Data
(60) Provisional application No. 61/254,907, filed on Oct. 26, 2009.

(51) Int. Cl. B65D 6/00; B65D 90/02; B31B 17/14; B31B 17/00

(52) U.S. Cl. 206/524.6; 220/4.28; 493/56; 493/84

(57) ABSTRACT

A modular storage container includes a one-piece canopy defining the roof and sidewalls of the storage container. A rear frame assembly, a front frame assembly, and a base assembly of the storage container are each coupled to the canopy. A method of manufacturing the canopy is provided as well.

### RELATED APPLICATIONS

This application claims priority under 35 U.S.C. §119(e) to U.S. Provisional Application Ser. No. 61/254,907, filed Oct. 26, 2009, which is expressly incorporated by reference herein.

### FIELD OF THE INVENTION

The present invention relates generally to storage containers such as mobile storage containers, cargo trailers, and semi-trailers, for example, and more specifically to modular storage containers.

### BACKGROUND

Storage containers, such as mobile storage containers, cargo trailers, and semi-trailers attached to a semi-tractor, for example, typically include a base or bottom wall, opposite side walls, and a top wall or roof. Such containers may further include end walls, front, and/or rear doors coupled to the base, side, and top walls. Further, such containers may include front and/or end frames as well. In particular, typical cargo trailers include sheet and post construction including thin-gage aluminum sheeting that is fastened to a formed steel or extruded aluminum post, fiberglass panels, and composite panels. The inside of the cargo trailer may also be covered with a liner material, such as plywood, for example. This wall assembly is then attached to a frame or base of the cargo trailer which typically consists of base rails, structural cross-members and flooring material. Such components are typically manufactured separately and assembled by the supplier. The walls may be coupled to each other by rivets, bolts, and/or welding, for example. This assembly process may be time consuming and thus increase the overall cost of the storage container to the customer. It is desirable to improve the structure, assembly, and/or operation of such storage containers.

### SUMMARY

The present invention may comprise one or more of the features recited in the attached claims, and/or one or more of the following features and combinations thereof.

According to one aspect of the present disclosure, a modular storage container includes a rear frame assembly, a front frame assembly, a base assembly coupled to the rear frame assembly and the front frame assembly, and a first one-piece canopy coupled to the rear frame assembly and the base assembly. Illustratively, the one-piece canopy may include a roof and first and second sidewalls coupled to and extending downwardly from the roof. Further, a height of each of the first and second sidewalls may be different than a width of the roof.

In another illustrative embodiment, the first one-piece canopy may be made from a composite material. The composite material may include an outer metal skin, an inner metal skin, and a plastic core coupled to and positioned between the inner and outer metal skins.

In yet another illustrative embodiment, the one-piece canopy may be made from a sheet having two grooves formed therein. Illustratively, each groove may be routed into an outer surface of the sheet. Further illustratively, the canopy may be formed to include a 90 degree bend at the location of each groove. In some embodiments, the groves may be formed by removing portions of the inner skin and the plastic core. The grooves may be sealed by sealant. The grooves may be covered with a metal doubler. The sealant may secure the doubler to a skin of the sheet.

In still another illustrative embodiment, the modular storage container may further include a second one-piece canopy coupled to the first one-piece canopy, the front frame assembly, and the base assembly. The modular storage container may also include an H-bracket coupled to each of the first and second one-piece canopies. Alternatively, the first and second canopies may be coupled together to form a shiplap joint.

According to another aspect of the present disclosure, a sheet structure is configured to be formed into a canopy of a storage container, wherein the canopy is configured to be coupled to a rear end assembly, a front end assembly, and a base assembly of the storage container. Illustratively, the sheet structure includes a one-piece body having an outer surface, an inner surface, a front end surface, and a rear end surface. The body further includes a first groove formed in the outer surface between the front end surface and the rear end surface, and a second groove formed in the outer surface between the front end surface and the rear end surface.

In one illustrative embodiment, the first and second grooves may be parallel to each other.

In another illustrative embodiment, the first and second grooves may each be V-shaped in cross-section.

In still another illustrative embodiment, the one-piece sheet may be made of a composite material. Illustratively, the composite material may include an outer metal skin, an inner metal skin, and a plastic material coupled to and positioned between each of the outer and inner metal skins. Further illustratively, the first and second grooves may be formed on in the outer skin. In some embodiments, the grooves may be formed in the inner skin. The grooves in the inner skin may be formed by removing portions of the inner skin and portions of the plastic material.

In yet another illustrative embodiment, the body may be configured to be bent 90 degrees along each of the first and second grooves to form the canopy having a roof and first and second sidewalls coupled to and depending downwardly from the roof.

According to yet another aspect of the present disclosure, a canopy of a storage container is provided. The canopy is configured to be coupled to a rear end assembly, a front end assembly, and a base assembly of the cargo container. Illustratively, the canopy includes a one-piece sheet defining a roof, a first sidewall configured to be coupled to the rear frame assembly, the front frame assembly, and the base assembly, and a second sidewall parallel to the first sidewall and configured to be coupled to the rear frame assembly, the front frame assembly, and the base assembly. The canopy further includes a first groove formed in the sheet and positioned between the roof and the first sidewall, and a second groove formed in the sheet and positioned between the roof and the second sidewall.

In one illustrative embodiment, the sheet may be made from a composite material including an outer metal skin, an inner metal skin, and a plastic core positioned between the inner and outer metal skins. Illustratively, the first and second grooves may be formed in the outer metal skin. In other embodiments grooves may be formed in the inner skin by removing portions of the inner skin and portions of the plastic core.

According to yet another aspect of the present disclosure, a method of manufacturing a canopy for a cargo container includes providing a sheet of material, machining two parallel grooves in one surface of the sheet of material, and bending the sheet of material 90 degrees at each of the machined grooves to create a U-shaped canopy. Illustratively, the grooves each extend from a front end of the sheet of material to the rear end of the sheet of material.

In one illustrative embodiment, the sheet of material may be a composite material including an outer metal skin, an inner metal skin, and a plastic core coupled to and positioned between the outer and inner skins. Illustratively, the grooves may be machined in the outer metal skin of the composite material. In other embodiments, the grooves may be formed in the inner skin by removing portions of the inner skin and portions of the plastic core.

In another illustrative embodiment, machining the grooves may include machining two V-shaped grooves.

In still another illustrative embodiment, bending the sheet of material may include heating the sheet of material and bending the sheet of material around a form at the location of each groove.

According to still another aspect of the present disclosure, a method of assembling a cargo container includes bending a sheet of material to create two 90 degree bends to form a monolithic U-shaped canopy forming the roof and sidewalls of the cargo container, coupling the sidewalls of the canopy to a base assembly, coupling a rear frame assembly to the sidewalls and roof of the canopy, and coupling a front frame assembly to the sidewalls roof of the canopy.

### BRIEF DESCRIPTION OF THE DRAWINGS

FIG. 1 is a rear, perspective view of a cargo trailer including a rear frame assembly, a front frame assembly, a base assembly, and a one-piece canopy coupled to the rear, front and base assemblies.

FIG. 2 is a front, perspective view of the cargo trailer of FIG. 1.

FIG. 3 is a perspective view of the canopy in sheet form prior to being bent to form the roof and side walls of the cargo trailer shown in FIG. 1.

FIG. 4 is an exploded, perspective view of the cargo trailer of FIG. 1.

FIG. 5 is a front view of a portion of the cargo trailer of FIG. 1 showing the canopy coupled to the base assembly;

FIG. 6 is a front view of a portion of an alternative cargo trailer showing the canopy coupled to the base assembly by the use of inner and outer flanges.

FIG. 7 is a perspective view showing multiple canopies coupled to one another by H-brackets.

FIG. 8 is an end view of a portion of two alternative canopies coupled to one another showing a ship-lap joint between the two canopies.

FIGS. 9a and 9b are perspective views showing an alternative canopy in sheet form (shown in FIG. 9a) to create a formed canopy (shown in FIG. 9b) including a roof and sidewalls having different dimensions than that of the canopy shown in FIGS. 1-3.

FIG. 10 is a perspective view of another canopy sheet form.

FIG. 11 is a perspective view of a portion of a canopy assembly including a canopy sheet similar to the canopy sheet of FIG. 10, the canopy sheet of FIG. 11 being bent to form a portion of a canopy.

FIG. 12 is an end view of a portion of a canopy assembly including a canopy sheet formed from the canopy sheet form of FIG. 10.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same. While the concepts of this disclosure are described in relation to a towable trailer, it will be understood that they are equally applicable to any vehicle including tractors, the trailers or storage and/or transportable containers towed by such tractors, straight truck bodies, small personal and/or commercial trailers (such as cargo trailers, for example), mobile storage containers and the like. Furthermore, the concepts of this disclosure are applicable to any other vehicle including all types of cars, trains, etc.

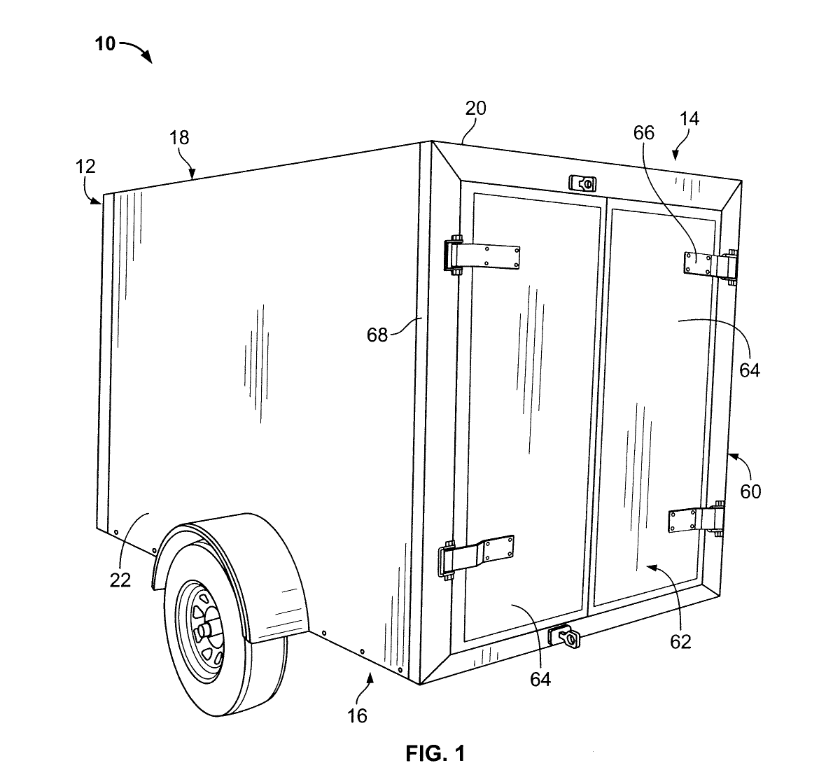

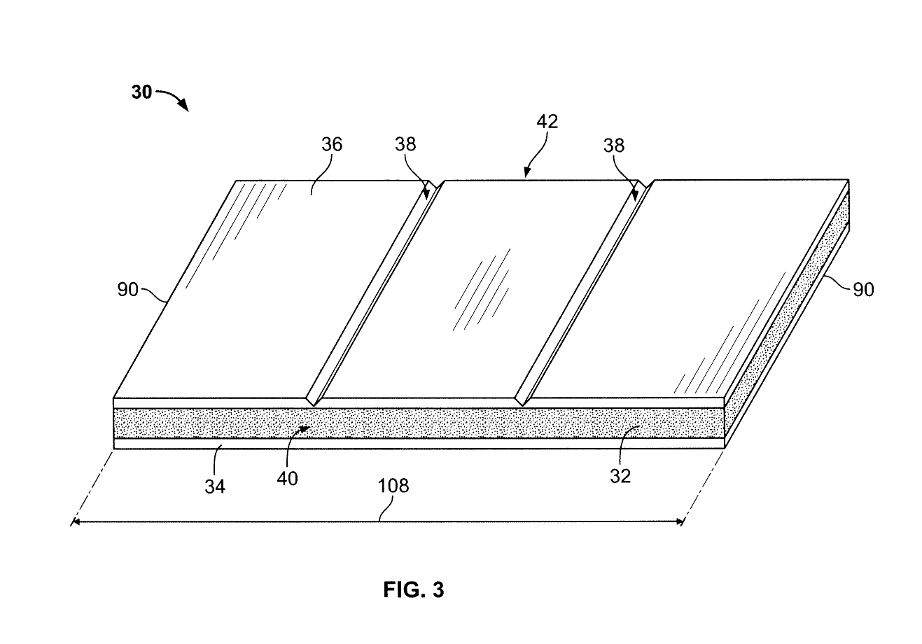

A modular storage container, such as the cargo trailer 10 shown in FIG. 1, includes a front frame assembly 12, a rear frame assembly 14, a base assembly 16, and a canopy 18 coupled to each of the front, rear, and base assemblies 12, 14, 16, as shown in FIGS. 1, 2 and 4. Illustratively, the canopy 18 is a one-piece, or monolithic, structure which defines the roof 20 and sidewalls 22 of the cargo trailer 10. This one-piece design operates to eliminate the typical connecting structures between a wall assembly and a roof assembly and the labor required to assemble them. As is discussed in greater detail below, the canopy structure 18 is made from a single sheet 30 (shown in FIG. 3) representing the canopy 18 in a pre-formed orientation. As such, this flat sheet 30 may be shipped to a customer or other end user in a flat, pre-formed state and may then be formed, or bent, onsite into the canopy 18 shown in FIGS. 1, 2, and 4 to create the roof 20 and sidewalls 22 for a storage container, such as cargo trailer 10. As such, multiple sheets 30 may be stacked on another and shipped together, thus minimizing or eliminating the need for any special shipping methods or extra shipping charges. Illustratively, while the canopy 18 is shown for use with the cargo trailer 10, the canopy 18 may be sized and configured for use with a semi-trailer, a truck body, or other suitable storage container applications.

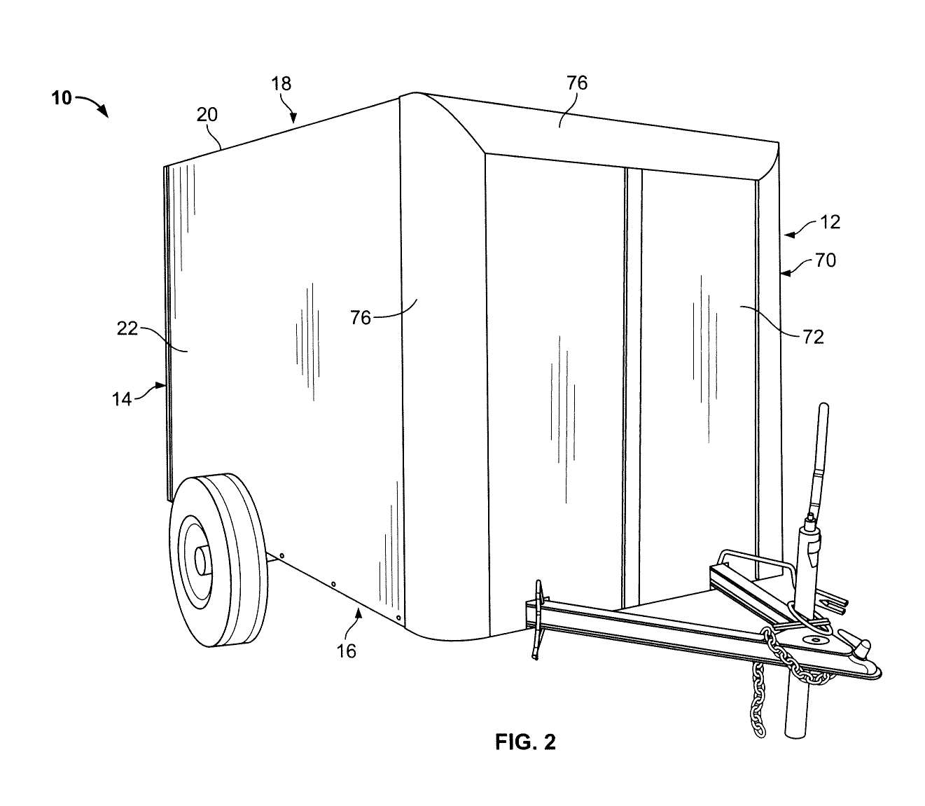

Looking again to FIGS. 1 and 2, the canopy structure 18 is in a formed orientation to define the roof 20 and sidewalls 22 of the cargo trailer 10. Illustratively, the formed canopy 18, and thus the sheet 30, is made from a composite material. However, it is within the scope of this disclosure for the canopy 18 and sheet 30 to be made from any number of suitable, non-composite materials such as metals, metal alloys, and/or plastics, for example. The illustrative composite material of the sheet 30 includes a plastic core 32 and inner and outer metal skins 34, 36 coupled to the plastic core 32. Such a composite material provides a rigid, but lightweight and durable material. Illustratively, for example the canopy 18, and thus the sheet 30, may be made of a DURAPLATE® composite panel provided by Wabash National Corporation of Lafayette, Ind. DURAPLATE® composite panels are constructed of a high-density polyethylene plastic core bonded between two high-strength steel skins. Illustratively, the composite material (i.e., the sheet 30) is approximately ¼″ thick. As such, using this composite material for the roof 20 and sidewalls 22 of the cargo trailer 10 (as oppose to the use of posts, panels, and/or liner materials, for example) allows for a larger inside width of the cargo trailer which provides more interior volume in which to haul or store cargo. While the illustrative sheet 30 is made of the particular composite material described above, it should be understood that other suitable composite materials may be used as well.

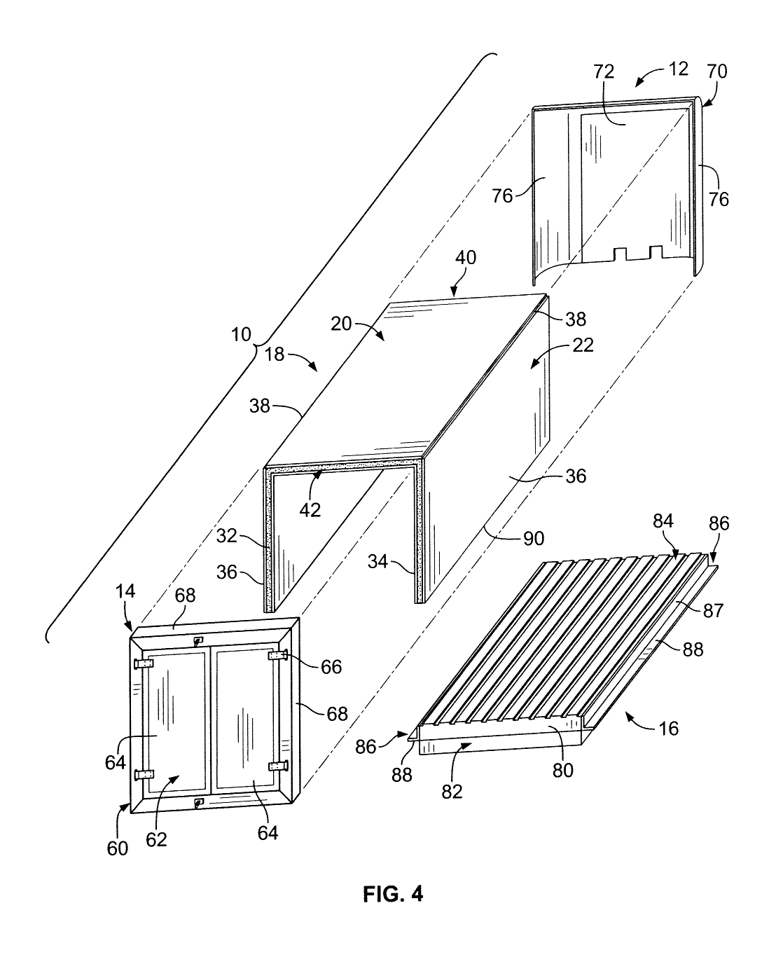

The sheet 30 and the canopy 18 also include bend lines or grooves 38, as shown in FIG. 3. These grooves 38 are formed in the outer metal skin 36 and provide the location of the 90 degree bend in the canopy 18. In other words, the canopy 18 includes a 90 degree bend at the location of each groove 38 to create a generally U-shaped structure, as shown in FIG. 4. Illustratively, the grooves 38 are parallel to each other and extend from a front end 40 of the sheet 30 to a rear end 42 of the sheet 30 thus defining three panels of the sheet. For example, a center panel of the sheet 30 will form the roof 20 of the canopy 18 and resulting cargo trailer 10, and each side panel of the sheet 30 will form a sidewall 22 of the canopy 18 and resulting cargo trailer 10. Illustratively, the grooves 38 may be made by a route-and-fold process. The route-and-fold process involves machining, or routing, a generally V-shaped groove, such as the grooves 38, in the outer skin 36 of the sheet 30 where it is desired for the 90 degree bend to occur to form the canopy 18. A machine may be used to bend the sheet 30 at the location of the grooves 38 to create the two 90 degree bends of the canopy 18. Alternatively, the sheet 30 may be bent manually or may be thermally formed to create the 90 degree bends of the canopy 18. Illustratively, the grooves 38 only extend into the outer skin 36 and do not extend into the plastic core 32 of the sheet 30. However, it is within the scope of this disclosure to provide a sheet 30 having grooves 38 which extend any suitable depth into the body of the sheet 30.

In an alternative embodiment, bend lines (not shown) may be formed by cutting through the inner skin 34 approximate to where the desired bend of the resultant canopy 18 is to be formed. After the cut is formed, the sheet may be thermally formed such that it is heated and bent 90 degrees around a form at or approximate to each cut. As such, these cuts through the inner skin 34 operate to allow the inner skins 34 to slip past each other when the 90 degree bends are formed.

Looking now to FIG. 4, once the flat sheet 30 has been shipped to its destination and the two 90 degree bends have been formed thus creating the canopy 18, the front frame assembly 12, rear frame assembly 14, and base assembly 16 may be coupled to the canopy 18 to form the cargo trailer 10. Illustratively, the rear frame assembly 14 includes a rear frame 60 and a door assembly 62 coupled to the rear frame 60. The rear frame 60 includes vertical and horizontal members while the door assembly 62 includes a pair of doors 64, hinges 66, and a locking assembly (not shown) coupled to the rear frame 60 and each door 64. Illustratively, the rear frame 60 may be made of steel or aluminum and generally operates to provide a door frame of the cargo trailer 10. The door frame 60 further operates to help support the canopy 18. In other words, the rear frame 60 of the rear frame assembly 14 operates to help prevent the canopy 18 from falling or collapsing laterally to either side and thus “rhombusing.” As shown in FIG. 3, the rear frame assembly 14 further includes flange members 68 coupled to and extending outwardly from each of the upper vertical and lateral frame members 60. The flange members 68 are configured to be coupled to the rear end 42 of the canopy 18. Illustratively, the flange members 68 are positioned adjacent the outer skin 36 of the roof 20 and sidewalls 22 of the canopy 18 and are coupled to the canopy 18 using fasteners (not shown) such as rivets, bolts, nails, screws, or welds, etc. However, the flange members 68 may also be coupled to the canopy 18 using an adhesive with or without additional fasteners. Illustratively, while the particular rear frame assembly 14 is shown in FIGS. 1 and 4, it is within the scope of this disclosure to include a modular cargo trailer having another suitable rear frame assembly as well.

As shown in FIG. 4, the cargo trailer 10 further includes the front frame assembly 12. Illustratively, the front frame assembly 12 includes a front frame 70 coupled to the front end 40 of the canopy 18 and a nose 72 coupled to the front frame 70. Similar to the rear frame 60, the front frame 70 includes vertical and horizontal members which generally operate to help support the canopy 18 and prevent the canopy 18 from falling laterally to either side and rhombusing. As shown in FIG. 4, the front frame assembly 12 further includes flange members 76 coupled to and extending outwardly from the front frame 70. These flange members 76 are configured to be coupled to the front end 40 of the canopy 18. Illustratively, the flange members 76 are positioned adjacent the outer skin 36 of the roof 20 and sidewalls 22 of the canopy 18 and are coupled to the canopy 18 using fasteners (not shown) such as rivets, bolts, nails, screws, welds, etc. However, the flange members 76 may also be coupled to the canopy 18 using an adhesive with or without additional fasteners. Illustratively, while the particular front end assembly 12 is shown in FIG. 4, it is within the scope of this disclosure to include a modular cargo trailer having another suitable front end assembly as well.

As noted above, the modular cargo trailer 10 further includes a base assembly 16. Illustratively, the base assembly 16 includes a perimeter base frame 80 having a front member, a rear member, and two side members coupled to and extending between the front and rear members. The base assembly 16 further includes cross-members 82 coupled to the frame 80. The base frame 80 and the cross-members 82 are made of metal, such as steel or aluminum, however other suitable metals and metal alloys, as well as other suitable materials, such as wood, plastic, and/or composites, may be used as well. Floor planks 84 are coupled to the perimeter frame 80 and the cross-members 82 and form the floor of the modular cargo trailer 10. These floor planks 84 may be made of wood, plastic, and/or metal. Further, while floor planks 84 are shown in FIG. 4, it is within the scope of this disclosure to include a base assembly having wood, plastic, and/or metal sheeting to form the floor of the trailer 10 as well.

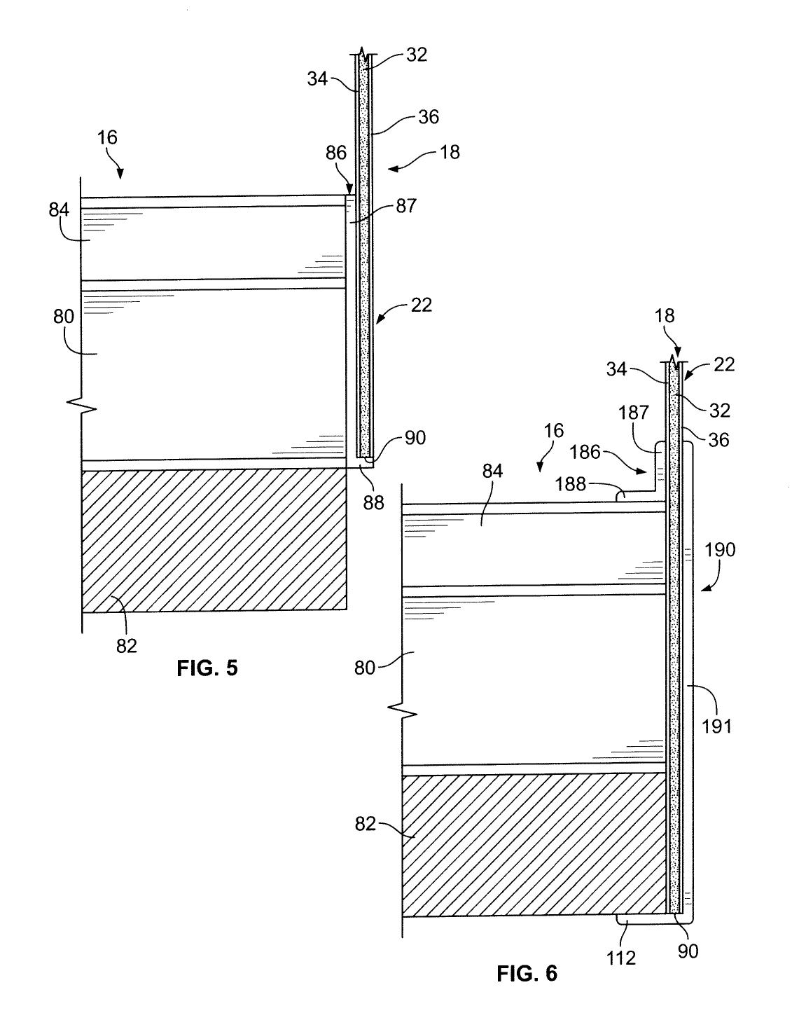

As shown in FIGS. 4 and 5, the base assembly 16 further includes two flanges 86 coupled to the floor planks 84 and the base frame 80. Each flange 86 is positioned along an outer edge of the base assembly 16 to extend along a length of the base assembly 16 from the front end of the base assembly 16 to the rear end of the base assembly 16, as shown in FIG. 4. The flanges 86 are L-shaped and each include a vertical member 87 adjacent and coupled to the base frame 80 as well as a horizontal lip 88 coupled to the vertical member 87 and extending outwardly from the vertical member 87 in a direction away from the base assembly 16. A respective bottom or side end 90 of each sidewall 22 of the canopy 18 rests on the lip 88 such that the lip 88 helps to support the canopy 18 thereon. As such, the flange members 86 are configured to be coupled to a respective side or bottom end 90 of the sidewalls 22 of the canopy 18. Illustratively, the flange members 86 are positioned adjacent the inner skin 34 of the sidewalls 22 of the canopy 18 and are coupled to the canopy 18 using fasteners (not shown) such as rivets, bolts, nails, screws, welds, etc. However, the flange members 86 may also be coupled to the canopy 18 using an adhesive with or without additional fasteners. The front and rear frame assemblies are also coupled to the base assembly through the use of fasteners such as rivets, bolts, nails, screws, and/or adhesive, etc. Illustratively, while the particular base assembly 16 is shown in FIG. 3 and described above, it is within the scope of this disclosure to include a modular storage container having any suitable base assembly.

Looking now to FIG. 6, an alternative connecting structure is provided to couple the canopy 18 to the base assembly 16 of the cargo trailer 10. In particular, the connecting structure includes first and second flanges 186, 190. Illustratively, the first flange 186 is L-shaped and includes a vertical member 187 and a horizontal member 188. The first flange 186 is positioned inside the cargo trailer 10 such that the vertical member 187 is adjacent the inner skin 34 of the sidewall 22 of the canopy 18 and the horizontal member 188 is adjacent the floor planks 84 of the base assembly 16. The first flange 186 is coupled to both the sidewall 22 of the canopy 18 and the base assembly 16 using fasteners (not shown) such as rivets, bolts, nails, screws, welds, etc. However, the first flange 186 may also be coupled to the canopy 18 and base assembly 16 using an adhesive with or without additional fasteners.

Similar to the first flange 186, the second flange 190 is L-shaped and includes a vertical member 191 and a horizontal member 192. The second flange 190 is positioned outside the cargo trailer 10 such that the vertical member 191 is adjacent the outer skin 36 of the sidewall 22 of the canopy and the horizontal member 192 is adjacent a bottom surface of one of the cross-members 82 of the base assembly 16. The second flange 190 is coupled to both the sidewall 22 of the canopy 18 and the base assembly 16 using fasteners (not shown) such as rivets, bolts, nails, screws, welds, etc. However, the second flange 190 may also be coupled to the canopy 18 and base assembly 16 using an adhesive with or without additional fasteners. Illustratively, the first and second flanges 186, 190 may each extend the entire length of the base assembly 16. Alternatively, each of the first and second flanges 186, 190, as well as the flanges 86 shown in FIG. 5, may extend only partially along the length of the base assembly 16; as such, multiple flanges 86, 186, 190 may be used to attach each sidewall 22 of the canopy 18 to the base assembly 16.

Illustratively, as noted above, the canopy 18 is formed by providing composite sheeting and forming two parallel grooves 38 into the sheeting to form the sheet 30. The sheet 30 may then be shipped to an end user and bent at the grooves 38 to form the 90 degree bends of the canopy 18. The end user may bend the sheet 30 at the grooves 38 manually, or may thermally form the 90 degree bends. Once the canopy 18 is formed, the canopy 18 may be clamped or otherwise coupled to the base assembly 16 in order to form the cargo trailer 10. Once the canopy 18 is coupled to the base assembly 16, the rear frame assembly 14 and the front frame assembly 12 may be coupled to the base assembly 16 and the canopy 18 to form the fully-assembled cargo trailer 10.

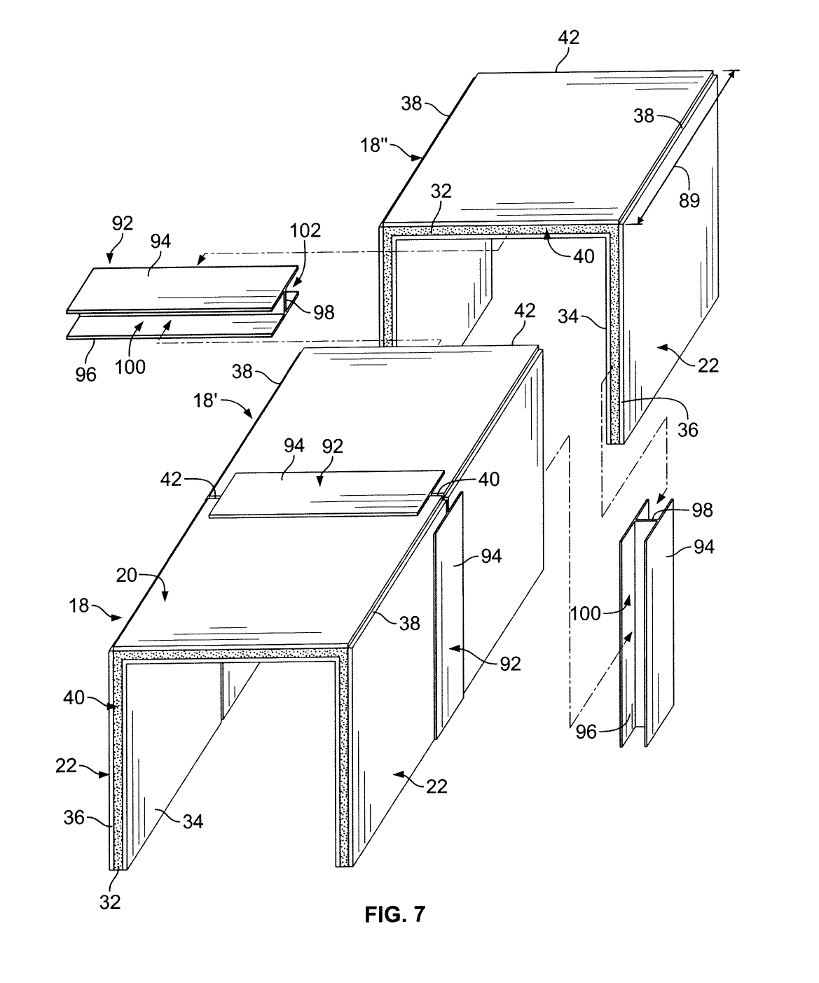

Looking now to FIG. 7, an illustrative width (or depth) of a single sheet 30, and thus the depth 89 of the canopy 18, (as measured from the front end 40 of the canopy 18 to the rear end 42 of the canopy 18) is approximately four feet. However, it is within the scope of this disclosure to provide sheets having any suitable width to create canopies having any suitable depth. Further illustratively, the overall depth of a cargo trailer may be may be increased by coupling two or more canopies 18 to one another in order to create a cargo trailer having a depth greater than that of a single sheet 30. Illustratively, the canopies 18, 18′, 18″ are coupled to each other by an H-bracket 92. As shown in FIG. 7, an H-bracket is generally “H-shaped” in cross section and includes an outer wall 94, an inner wall 96 parallel to the outer wall 94, and a cross-wall 98 coupled to and positioned between the inner and outer walls 96, 94. As such, each H-bracket 92 includes first and second channels 100, 102 formed therein. Illustratively, the rear end 42 of each sidewall 22 and roof 20 of a first canopy 18 is received within the first channel 100 of a respective H-bracket 92 while the front end 40 of each sidewall 22 and roof 20 of a second canopy 18′ is received within the second channel 102 of the respective H-bracket 92 in order to secure the first and second canopies 18, 18′ to each other. In use, the H-bracket 92 may be press-fit onto the ends of each respective roof 20 and sidewall 22. Alternatively, the H-bracket may be coupled to each canopy 18 via fasteners (not shown) such as rivets, bolts, nails, screws, welds, etc. Further alternatively, adhesive may be used alone or in combination with one or more of the aforementioned fasteners as well. As such, any number of canopies, such as the canopies 18, 18′, and 18″ shown in FIG. 7, may be coupled to each other to form a cargo container having any desired depth.

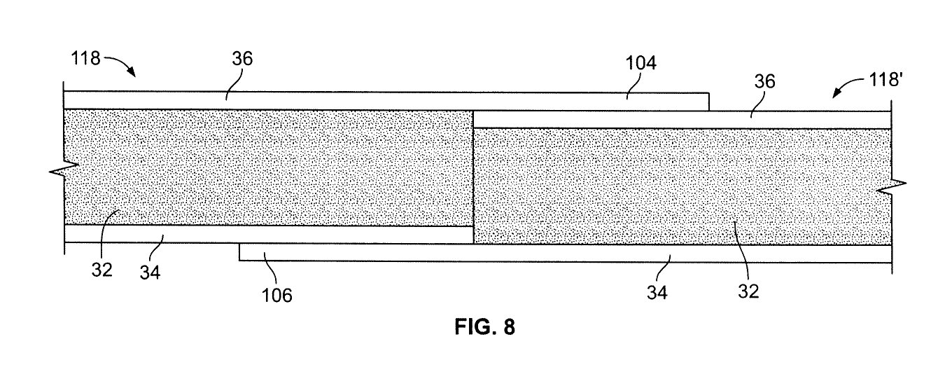

While the H-brackets 92 shown in FIG. 7 are provided to connect the canopies 18, 18′, 18″ to one another, it is within the scope of this disclosure to include other connecting structures as well. For example, the rear end 42 of each canopy 18 may include a flange or extension member 104 configured to extend outwardly from the outer skin 36 of the canopy 118, as shown in FIG. 8. Similarly, the front end 40 of each canopy 118′ may include a flange or extension member 106 configured to extend outwardly from the inner skin 34 of the canopy 118′ such that flanges 104, 106 of adjacent canopies 118, 118′ overlap to create a shiplap joint. In particular, as shown in FIG. 8, the flange 104 of the canopy 118 is positioned adjacent the outer skin 36 of adjacent canopy 118′ while the flange 106 of the canopy 118′ is positioned adjacent the inner skin 34 of the adjacent canopy 118.

These shiplap flanges 104, 106 may be adhesively bonded to the respective outer and inner skins 36, 34 of the adjacent canopies 118, 118′ and/or may be coupled to the adjacent canopies 118, 118′ through the use of fasteners (not shown) such as rivets, screws, bolts, or nails, or welds, for example. A similar shiplap joint used in conjunction with a composite panel is also illustratively described in U.S. patent application Ser. No. 12/400,384 filed Mar. 3, 2009 and titled “Roof Assembly for a Storage Container,” the entirety of the disclosure of which is hereby incorporated by reference herein.

In yet another embodiment, adjacent canopies 18 may be coupled to each other through the use of interior and/or exterior battens (not shown). For example, a strip or bracket may be positioned over the seam created by adjacent canopies 18 and the bracket may be subsequently fastened to each of the adjacent canopies. Again, the battens may be adhesively bonded to the adjacent canopies 18 and/or may be coupled to the adjacent canopies 18 through the use of any other suitable fasteners.

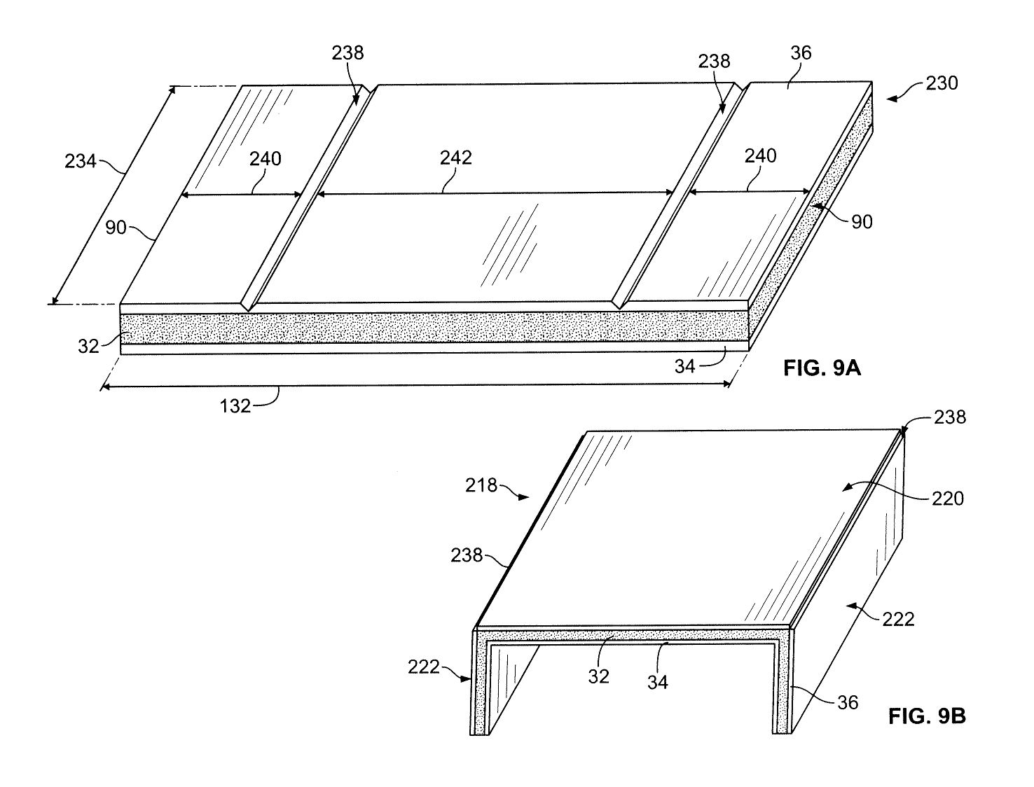

While the depth of the cargo trailer 10 may be altered by coupling multiple canopies 18 to one another, the height and width of the cargo trailer 10 may also be altered simply by changing an overall length 108 of the sheet 30 (as shown in FIG. 3) from which the canopy 18 is formed and/or by changing the position of the bend lines or grooves 38 formed in the sheet 30. As shown in FIG. 9a, for example, an alternative sheet 230 defines a length 232 and a width 234. Illustratively, each of the first and second grooves 238 are located a distance 140 from each of the side ends 90 of the sheet 230 in order to form a canopy 218 having sidewalls 222 with a height equal to distance 238. Illustratively, a distance 242 between the grooves 238 is greater than the distance 240 between each groove 238 and the adjacent side end 90 of the sheet 230 such that the roof 220 of the canopy 218 has a width greater than the height of each of the sidewalls 222 of the canopy 218. Illustratively, while FIG. 9a illustrates a particular sheet 230 having a particular length 232 and grooves 238 positioned a certain distance from each side end 90 of the sheet 230, it is within the scope of this disclosure to include cargo containers having canopies formed from sheets of any size having bend lines located any distance from the side end of the sheet. In other words, it is within the scope of this disclosure to include canopies having any height, width, and depth (or length). As such, cargo containers made from such canopies may be made in infinitely variable sizes in all three dimensions. The desired height of the sidewalls and the desired width of the roof of each canopy will determine the overall length of the sheet and the location of the grooves to define the junction between the sidewalls and the roof of the canopy where the 90 degree bend of the canopy is to be formed.

Illustratively, the canopies 18, 218 described above form the roof and sidewalls of a cargo trailer. However, it is within the scope of this disclosure for the same canopy structure to form the front or nose end and sidewalls of a cargo trailer. The alternative body structure (not shown) is the same as or similar to that of the canopies 18, 118. However, while the canopies 18, 118 are each oriented to define the roof 20 and sidewalls 22 of the cargo trailer 10, the alternative body structure may be positioned to define the nose and sidewalls of resulting cargo container (not shown). Illustratively, therefore, a rear frame assembly, such as the rear frame assembly 14, is coupled to the sidewalls of the body structure, a roof assembly (not shown) is coupled to the nose and sidewalls of the body structure, while a base assembly, such as the base assembly 16, is coupled to the nose and sidewalls of the body structure 218 to define an alternative cargo container (not shown). In this configuration, the grooves of the body structure are positioned to extend longitudinally to define a height of the container when the cargo container is fully assembled, as opposed to the grooves 38 of canopy 18 which extend laterally along a length (or depth) of the cargo trailer 10 when the trailer 10 is fully assembled.

In this alternative configuration where the body structure forms the nose and sidewalls of the cargo trailer, an overall height of the cargo trailer may be increased by stacking the canopy body structures on top of each other and connecting the canopy structures to one another using H-brackets, ship-lap joints, or battens, for example. The overall sheet length on the other hand determines the width and length (or depth) of the cargo container. Thus, adjusting the overall length of the sheet from which the body structure is formed as well as adjusting the position of the grooves or bend lines in the sheet will operate to determine the length (or depth) and width of the resultant cargo container.

Further, another body structure (not shown) may be provided which defines the rear end wall and sidewalls of a cargo trailer 10 when coupled with a front end assembly, a roof assembly, and a base assembly. In other words, the formed sheet which creates the canopy structure may be oriented in any suitable way to define three of the six walls of a resultant cargo container. It is further within the scope of this disclosure to provide a sheet having more than two grooves or bend lines formed therein in order to create a structure having more than three walls once each of the wall portions approximate a bend line, or groove, are bent 90 degrees. Further, while canopies disclosed herein each include two bends of approximately 90 degrees to form three panels (i.e., the roof 20 and two sidewalls 22), it is within the scope of this disclosure to include a sheet and/or canopy having more than two grooves to create more than three panels. It is also within the scope of this disclosure to form a canopy structure including bends defining acute or obtuse angles as well as the 90 degree angles described herein.

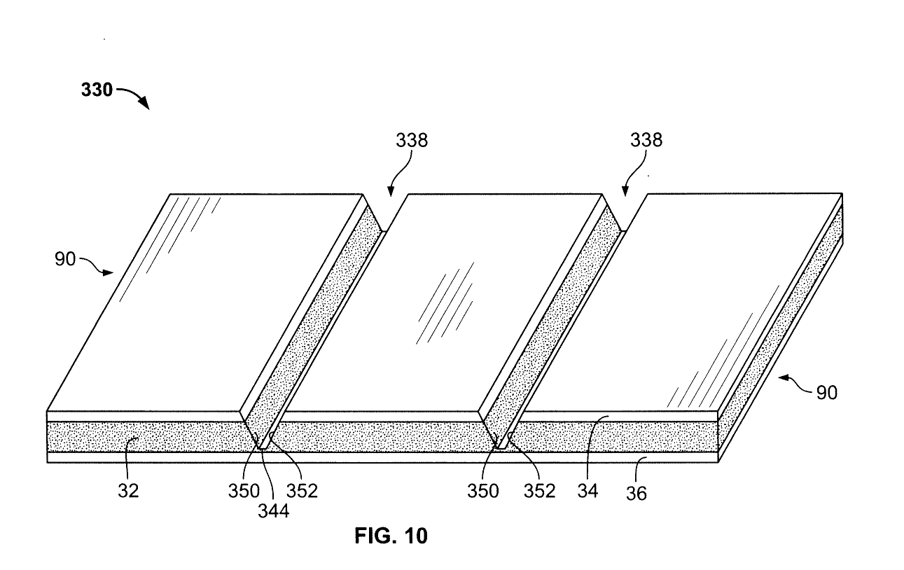

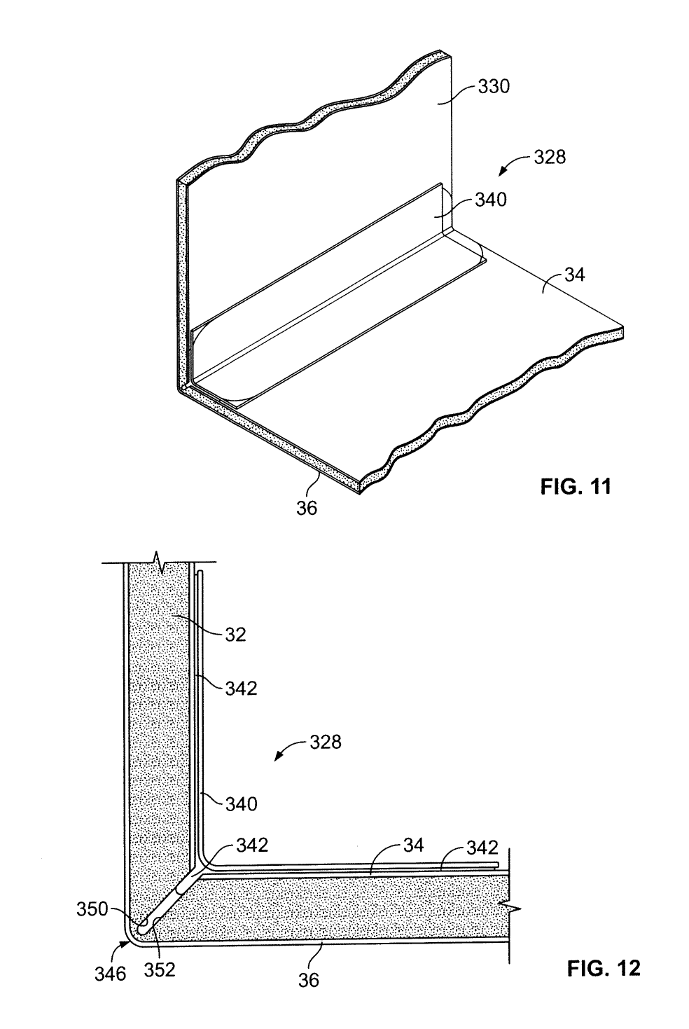

In another embodiment shown in FIGS. 10-12, an assembly 328 may be used to form any of the canopies 18, 118, 218. The assembly 328 comprises a sheet 330. The sheet 330 is similar to sheets 30 and 230 but includes grooves 338 formed by machining through the inner skin 34 and into the plastic core 32 leaving a portion 344 of the plastic core 32 adjacent to the outer skin 36. The grooves 338 have opposing walls 350 and 352 which cooperate to define an angle of about a 90° so that as the sheet 330 is folded at the grooves 338, the plastic core 32 approximately meets as shown in FIG. 12. The sheet 330 may be folded or formed using any of the processes described with regard to sheets 30 and 230. In addition, assembly of adjacent sheets 330 may be accomplished using the techniques described with regard to sheets 30 and 230 discussed above.

When the sheet 330 is folded, the outer skin 36 forms a smooth outer radius 346, thereby improving the aesthetic presentation of a canopy 18, 118, 218 formed from the sheet 330. The groove 338 is partially filled with a sealant 342 with the sealant 342 being positioned in the groove 338 and on the outer surface of the inner skin 34. The inner skin 34 is partially covered with a metal doubler 340 that covers the exposed groove 338 on the interior of the canopy 18, 118, or 218 and cooperates with the inner skin 34 and sealant 342 to seal the interior of the canopy 18, 118, 218.

It should be understood that a sheet 330 may be dimensioned and used in any of the applications heretofore described with regard to sheet 30. The use of each of the sealant 342 and doubler 340 is optional. In the illustrative embodiment of FIGS. 10-12, the doubler 340 is secured to the inner skin 34 using the sealant 342. It should be understood that the doubler 340 may also be secured using other fasteners, such as screws, rivets, bolts, or the like.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. It should further be understood that various features of each of the grab handle assemblies 12, 112, 212 disclosed herein may be interchanged with each other and/or added onto other grab handle assemblies as well.

What is claimed is:

1. A modular storage container comprising:
a rear frame assembly;
a front frame assembly;
a base assembly coupled to the rear frame assembly and the front frame assembly; and
a first one-piece canopy coupled to the rear frame assembly and the base assembly.

2. The modular storage container of claim 1, wherein the one-piece canopy includes a roof and first and second sidewalls coupled to and extending downwardly from the roof.

3. The modular storage container of claim 2, wherein a height of each of the first and second sidewalls is different than a width of the roof.

4. The modular storage container of claim 1, wherein the first one-piece canopy is made from a composite material.

5. The modular storage container of claim 4, wherein the composite material includes an outer metal skin, an inner metal skin, and a plastic core coupled to and positioned between the inner and outer metal skins.

6. The modular storage container of claim 1, wherein the one-piece canopy is made from a sheet having two grooves formed therein.

7. The modular storage container of claim 6, wherein each groove is routed into a surface of the sheet.

8. The modular storage container of claim 7, wherein the groove is routed into the plastic core.

9. The modular storage container of claim 1, further comprising a second one-piece canopy coupled to the first one-piece canopy, the front frame assembly, and the base assembly.

10. The modular storage container of claim 9, further comprising an H-bracket coupled to each of the first and second one-piece canopies.

11. The modular storage container of claim 9, wherein the first and second canopies are coupled together to form a shiplap joint.

12. A sheet structure configured to be formed into a canopy of a storage container, the canopy being configured to be coupled to a rear end assembly, a front end assembly, and a base assembly of the storage container, the sheet structure comprising:
a one-piece body having an outer surface, an inner surface, a front end surface, and a rear end surface, a first groove formed in the outer surface between the front end surface and the rear end surface, and a second groove formed in the outer surface between the front end surface and the rear end surface.

13. The sheet structure of claim 12, wherein the first and second grooves are parallel to each other.

14. The sheet structure of claim 12, wherein the first and second grooves are each V-shaped in cross-section.

15. The sheet structure of claim 12, wherein the one-piece sheet is made of a composite material.

16. The sheet structure of claim 15, wherein the composite material includes an outer metal skin, an inner metal skin, and a plastic material coupled to and positioned between each of the outer and inner metal skins.

17. The sheet structure of claim 16, wherein the first and second grooves are formed in the outer skin.

18. The sheet structure of claim 16, wherein the first and second grooves are formed by removing portions of the inner skin and the plastic material.

19. The sheet structure of claim 12, wherein the body is configured to be bent 90 degrees along each of the first and second grooves to form the canopy having a roof and first and second sidewalls coupled to and depending downwardly from the roof.

20. A canopy of a storage container, the canopy being configured to be coupled to a rear end assembly, a front end assembly, and a base assembly of the storage container, the canopy comprising:
a one-piece sheet defining a roof, a first sidewall configured to be coupled to the rear frame assembly, the front frame assembly, and the base assembly, and a second sidewall parallel to the first sidewall and configured to be coupled to the rear frame assembly, the front frame assembly, and the base assembly; and
a first groove formed in the sheet and positioned between the roof and the first sidewall; and
a second groove formed in the sheet and positioned between the roof and the second sidewall.

21. The canopy of claim 20, wherein the sheet is made from a composite material including an outer metal skin, an inner metal skin, and a plastic core positioned between the inner and outer metal skins.

22. The canopy of claim 21, wherein the first and second grooves are formed in the outer metal skin.

23. The canopy of claim 21, wherein the first and second grooves are formed by removing portions of the inner metal skin and the plastic core.

24. A method of manufacturing a canopy for a storage container, the canopy being configured to be coupled to a rear end assembly, a front end assembly, and a base assembly of the storage container, the method comprising:
providing a sheet of material;
machining two parallel grooves in one surface of the sheet of material, wherein the grooves each extend from a front end of the sheet of material to the rear end of the sheet of material; and
bending the sheet of material 90 degrees at each of the machined grooves to create a U-shaped canopy.

25. The method of claim 24, wherein the sheet of material is a composite material including an outer metal skin, an inner metal skin, and a plastic core coupled to and positioned between the outer and inner metal skins.

26. The method of claim 25, wherein machining the two parallel grooves in one surface of the sheet of material includes machining the two parallel grooves in the outer metal skin of the composite material.

27. The method of claim 24, wherein machining the two parallel grooves in one surface of the sheet material includes machining two V-shaped grooves.

28. The method of claim 24, wherein bending the sheet of material includes heating the sheet of material and bending the sheet of material around a form at the location of each groove.

29. A method of assembling a storage container comprising:
bending a sheet of material to create two 90° degree bends to form a monolithic U-shaped canopy forming the roof and sidewalls of the storage container;
coupling the sidewalls of the canopy to a base assembly;
coupling a rear frame assembly to the sidewalls and roof of the canopy; and
coupling a front frame assembly to the sidewalls roof of the canopy.
